(19) United States
(12) Patent Application Publication
(10) Pub. No.: US 2014/0297285 A1
(43) Pub. Date: Oct. 2, 2014

(54) AUTOMATIC PAGE CONTENT READING-ALOUD METHOD AND DEVICE THEREOF

(71) Applicant: Tencent Technology (Shenzhen) Company Limited, Shenzhen (CN)

(72) Inventors: Kai Zhang, Shenzhen (CN); Bo HU, Shenzhen (CN); Tingyong TANG, Shenzhen (CN); Renfang LlU, Shenzhen (CN); Zhipei WANG, Shenzhen (CN); Ruiyi ZHOU, Shenzhen (CN); Xi WANG, Shenzhen (CN); Zhengkai XIE, Shenzhen (CN); Bosen HE, Shenzhen (CN); Ying HUANG, Shenzhen (CN); Wei LI, Shenzhen (CN); Cheng FENG, Shenzhen (CN); Huijiao YANG, Shenzhen (CN); Yulei LlU, Shenzhen (CN)

(21) Appl. No.: 14/303,902

(22) Filed: Jun. 13, 2014

Related U.S. Application Data
(63) Continuation of application No. PCT/CN2014/073550, filed on Mar. 17, 2014.

(30) Foreign Application Priority Data
Mar. 28, 2013 (CN) 201310104807.5

(51) Int. Cl. G10L 13/04; G10L 13/08

(52) U.S. Cl. CPC G10L 13/043; G10L 13/08
USPC 704/260

(57) ABSTRACT

The present disclosure discloses a page content reading method and device thereof. The method includes obtaining page content requested to browse, and determining whether a format of the page content meets a pre-determined requirement; it the format of the page content meets the pre-determined requirement, displaying the page content, and processing the page content into a form adapted for reading-aloud and automatically reading-aloud the processed page content, upon receiving a reading-aloud request; if the format of the page content does not meet the pre-determined requirement, displaying a page content, after the format of which having been converted into a format that meets the pre-determined requirement, and processing the page content into a form adapted for reading-aloud and automatically reading-aloud the processed page content, upon receiving a reading-aloud request from the user. The embodiment of the present invention can be widely applied and can bring down the cost of realization.

### REFERENCE TO PRIOR APPLICATIONS

The present application is a continuation of International Patent Application No. PCT/CN2014/073550, filed on Mar. 17, 2014, which claims priority to Chinese Patent Application No. 201310104807.5, titled “RAGE CONTENT READING-ALOUD METHOD AND DEVICE THEREOF” and filed in the Chinese Patent Office on Mar. 28, 2013, the entire contents of each of which are hereby incorporated by reference.

### TECHNICAL FIELD

The present disclosure relates to a network technology, in particular to an automatic page content reading method and the device thereof

### BACKGROUND

In order to facilitate a user to obtain page content, a page content reading-aloud technology has been proposed in the prior art, i.e. when the user needs to browse some page content, that page content may be read aloud by a system for the user, such that the user may conveniently obtain the page content by way of listening other than browsing.

The above technology will be quite practical in some situations such as when a user is driving and cannot easily manipulate a mobile phone.

In conventional methods, page reading-aloud technology is achieved mainly in the following two approaches:

1) The user installs a special novel-reading-aloud software on an terminal of his or her own, such as a mobile phone. So the user can browser the page content of any novel provided by the software, and can issue a reading-aloud request for any page content. Consequently, the software will automatically read-aloud the page content for the user.

2) For various page contents, corresponding reading-aloud materials may be generated respectively through human recordings and may then be stored. When a reading-aloud request for any page content is received from a user, corresponding reading-aloud material will be played.

However, it is greatly limited in terms of page content, i.e. it is only applicable to novels, and cannot be applied to read-aloud other types of page content such as news, forums or magazines. It has a limited range of applicability.

As various page contents are involved in practical applications, if human recordings should be performed to all of them, then the cost of realization will be very high including labor cost and storage cost etc.

### SUMMARY

In consideration of the above, the present disclosure provides an automatic page content reading-aloud method and the device thereof, which may automatically read-aloud a variety of page contents without having them previously human-recorded. It may be widely applied and may bring down the cost of realization.

According to an embodiment of the present disclosure, there is provided a method for automatically reading-aloud page content, comprising: obtaining page content requested to browse, and determining whether a format of the page content meets a pre-determined requirement; if it is determined that the format of the page content meets the pre-determined requirement, displaying the page content, and processing the page content into a form adapted for reading-aloud and reading-aloud the processed page content, upon receiving a reading-aloud request from the user; if it is determined that the format of the page content does not meet the pre-determined requirement, displaying a page content after the format of which having been converted into a format that meets the pre-determined requirement, and processing the page content into a form adapted for reading-aloud and reading-aloud the processed page content, upon receiving a reading-aloud request from the user.

According to another embodiment of the present disclosure, there is provided an automatic page content reading-aloud device, comprising an obtaining module and a reading-aloud module. The obtaining module is configured to obtain page content requested to browse and send the page content to the reading-aloud module. The reading-aloud module is configured to determine whether a format of the page content meets a pre-determined requirement. If it is determined the format of the page content meets the pre-determined requirement, the page content is displayed to the user, and upon receiving a reading-aloud request from the user, the page content is processed into a form adapted for reading-aloud, and the processed page content is automatically read-aloud, If it is determined the format of the page content does not meet the pre-determined requirement, then a page content is displayed to the user, the format of which having been converted into a format that meets the pre-determined requirement prior to the displaying, and upon receiving a reading-aloud request from the user, the page content is processed into a form adapted for reading-aloud and the processed page content is automatically read-aloud.

According to a further embodiment of the present disclosure, there is provided a computer program product stored on a computer readable medium and comprising computer program codes. The computer program codes, when being loaded into a computer system and executed thereon, perform the aforementioned method for automatically reading-aloud page content.

According to a further embodiment of the present disclosure, there is provided a computer readable medium with computer program product stored thereon, the computer program product comprising computer program codes. The computer program codes, when being loaded into a computer system and executed thereon, perform the aforementioned method for automatically reading-aloud page content.

According to a further embodiment of the present disclosure, there is provided a browser client, comprising: a content requesting module, being configured to send a request for page content to a server; a content receiving module, being configured to receive page content from the server, wherein the page content having been subject to a text content extraction and being divided into a first portion and a second portion, wherein the second portion being a pre-determined portion of content in the form of plain text, derived from the page content having been subject to the text content extraction; a content displaying module, being configured to display the received page content on a display screen, and display a reading-aloud triggering control component for triggering reading-aloud the second portion of the page content; and a content reading-aloud module, being configured to output the second portion of the page content in an automatic phonetic form in response to the triggering of the reading-aloud triggering control component.

With the page content automatic reading-aloud method and an apparatus thereof according to the embodiments of the present invention, compared with approach 1) of the prior art, the solution of the present invention is applicable to any page content, and instead of applicable to only novels, it is also applicable to all the other types of page contents, such as news, forum and magazine etc., thus expanding the range of applicability of the solution, i.e. the solution of the present invention is widely applicable; compared with approach 2) of the prior art, this solution does not require human recordings, thus reducing the cost of realization including labor cost and storage cost etc.

### BRIEF DESCRIPTION OF THE DRAWINGS

FIG. 1 is a diagram showing a network configuration of a system according to an embodiment of the present disclosure.

FIG. 2 is a schematic diagram of an operating environment of an automatic page content reading-aloud device according to an embodiment of the present disclosure.

FIG. 3 is a flow chart of an embodiment of an automatic page content reading-aloud method according to an embodiment of the present disclosure.

FIG. 4 is a flow chart of a preferred embodiment of an automatic page content reading-aloud method according to an embodiment of the present disclosure.

FIG. 5 is a schematic diagram of an embodiment of the constituent structure of an automatic page content reading-aloud device according to an embodiment of the present disclosure.

FIG. 6 is a diagram showing a configuration of a browser client according to a further embodiment of the present disclosure.

### DETAILED DESCRIPTION

To address the technical problem in the prior art, an improved page content reading-aloud scheme is proposed in an embodiment of the present disclosure, which utilizes an implementing manner combining a TN (Text To Speech) technology and a page body text extraction technology.

The TTS technology, also referred to as the Text to Speech technology, i.e. decomposing text into phonemes by characters or words, and obtaining voice corresponding to various phonemes by inquiring a voice database, and playing it through a speaker, with the played sound using human speaking standard Chinese as the standard pronunciation, a reading-aloud speed of up to 3 to 4 Chinese characters/second, thus allowing a user to hear clear and pleasing sound and smooth tones.

In a page body text extraction technology, after a user sends browsing request for a certain page content via a browser client, the page content is filtered and marked by an application server such as a backend server in order to filter out the content that a user is uninterested in and mark the beginning and end of the body text content, then, the browser client displays the body text content to the user according to the marks made by the backend server.

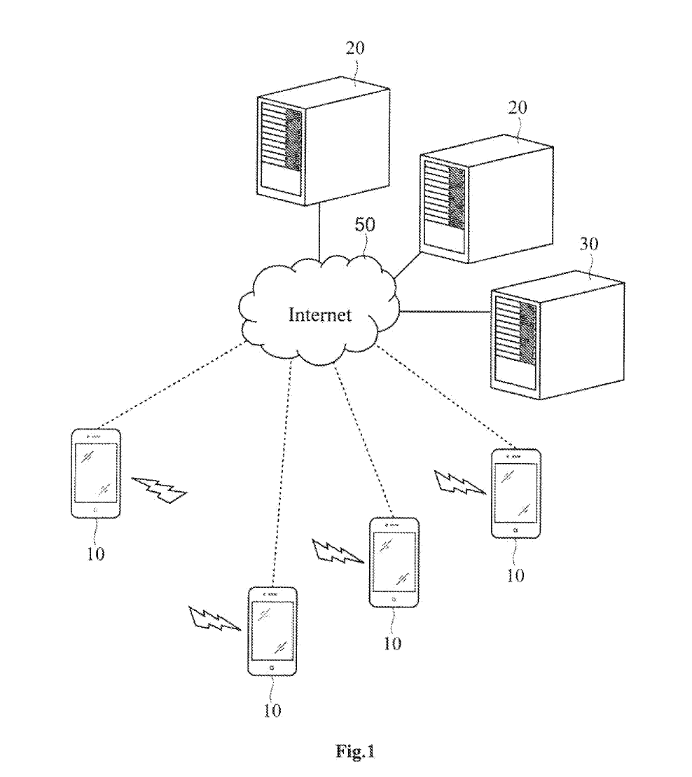

FIG. 1 is a diagram showing a network configuration of a system according to this embodiment.

As shown in FIG. 1, the system includes a plurality of terminal devices 10, a plurality of web content servers 20 and an application server 30. The terminal devices 10, the web content servers 20 and the application server 30 are capable of communicating with each other through a network 50 such as the internet.

The web content servers 100 provide content such as news, blog, and the like to the terminal devices 10.

The application server 30 provides services such as page body text content extraction to the terminal devices 10.

The terminal devices 10 may be any information processing apparatus such as a smart phone, a mobile phone, a tablet PC (Personal Computer), a desktop PC, a notebook PC, a PDA (Personal Digital Assistant), a portable AV (Audio-visual) player, an electronic book, a digital still camera, a camcorder, a television receiver, a PVR (Personal Video Recorder), a game machine, a projector, a car navigation system, a digital photo frame, an HDD (Hard Disk Drive) apparatus, a healthcare apparatus, and a household appliance.

In FIG. 1, four terminal devices are shown as examples. However, the number of terminal devices 200 may be less than four or more than five.

In one example, the functions of the web content server 20 and the application server 30 can be incorporated into one server.

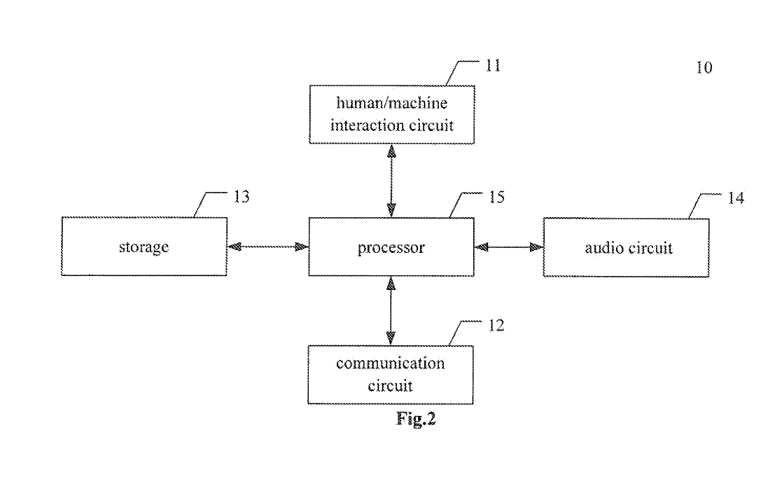

FIG. 2 is a schematic diagram of an operating environment of an automatic page content reading-aloud device according to an embodiment of the present disclosure. The automatic page content reading-aloud device may be incorporated in a browser client, as shown in FIG. 2, the browser client may comprise: a human/machine interaction circuit 11, a communication circuit 12, a storage 13, an audio circuit 14 and a processor 15 etc.

The human/machine interaction circuit 11 may be used for human/machine interaction, such as receiving a request from the user, and displaying the requested page content to the user. The communication circuit 12 may be configured to exchange information with a server, such as obtaining the requested page content from the server. The storage 13 may be configured to store program instructions corresponding to the above automatic page content reading-aloud device, and store page content obtained from the server and page content having been subject to various processing. The audio circuit 14 may be configured to play the read-aloud page content. The processor 15 may be configured to control (such as through the program instructions of the automatic page content reading-aloud device stored in the storage 13) each of the other parts to operate, and perform functions such as format conversion of page content and reading-aloud of page content by performing program instructions stored m the storage 13.

In order to make an embodiment of the present invention clearer and easier to be understood, the embodiment of the present invention will now be explained in details with reference to the drawings and by descriptions of the embodiment.

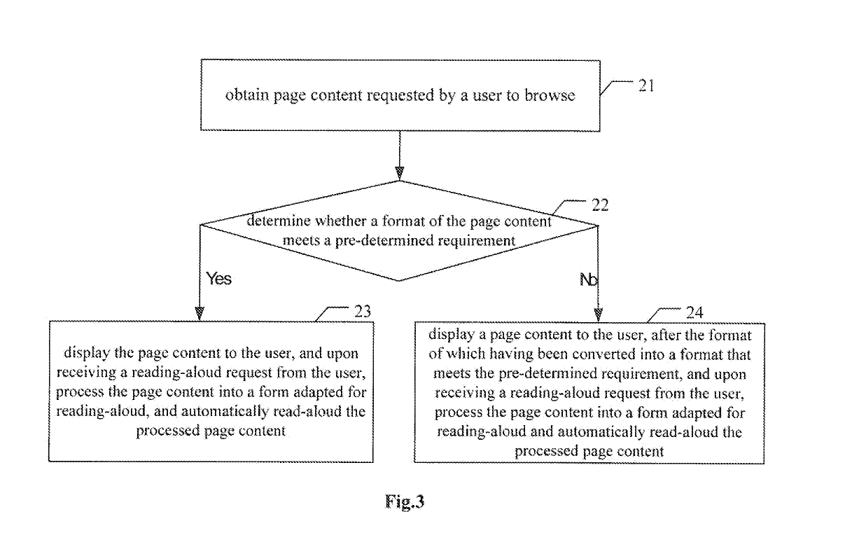

FIG. 3 is a flow chart of an embodiment of an automatic page content reading-aloud method according to an embodiment of the present disclosure. The method is applicable to a browser client. As shown in FIG. 3, the method comprises the following steps.

In step 21, page content requested by a user to browse is obtained.

For example, a user is browsing a webpage on the website with a browser application. When the user for example clicks on a hyperlink, a request is sent to a remote server (such as a web content server 20 shown in FIG. 1) for page content corresponding to the hyperlink. The remote server then returns requested page content to a browser client in response to the request.

In step 22, it is determined whether a format of the page content meets a pre-determined requirement. If yes, then the process proceeds to step 23, otherwise, the process proceeds to step 24.

In practice, upon receiving the browsing request from a user for any page content, it may be first determined whether the page content is one that has been subject to page body text extraction, and depending on different determination result, different processing approaches may be adopted, i.e. if it is determined that the page content is one that has been subject to page body text extraction, then the process proceeds to step 23, otherwise, the process proceeds to step 24.

In one example, in the case where the page content has been subject to page body text extraction, in the returned page content, pre-determined marks may be embedded/inserted into the head and tail of the page text, in order to indicate that content between the two marks is the portion that the user is interested in, as the result of the page body text extraction.

As it is known, webpage content is generally in an html format. The page content extraction technology may distinguish the body text from advertisement in the webpage content, thus dividing the page content into two portions, with the first portion being the portion of advertisement etc., a second portion being e.g. the body text portion that the user is interested in, and the head and tail of the second portion being marked. Such first and second portions are then provided to a browser application.

In one example, the operation of page body text content extraction may be performed by the same server as the source of the webpage content (such as the web content server 20 shown in FIG. 1). In another example, the operation of page body text content extraction may be performed by a second server (such as the application server 30 shown in FIG. 1) other than the server as the source of the webpage content (such as the web content server 20), the second server then combines the first and second portions of content that have been subject to the page content extraction to provide to the browser client. In a further example, the page body text content extraction technology may be inserted into the browser application as a module, i.e. the page body text content extraction of a webpage is performed by the browser application itself.

In step 23, the page content is displayed to the user, and upon receiving a reading-aloud request from the user, the page content is processed into a form adapted for reading-aloud, and the processed page content is automatically read-aloud.

If it is determined in step 22 that the page content is one that has been subject to page body text extraction, then in this step 23, the page content may be displayed to the user directly, and during the display, a “read-aloud” button ma appear in the menu of displaying interface, when the user clicks on the button, it could be deemed that the user has sent out a read-aloud request. Correspondingly, the TTS technology may be used to process the page content into a form adapted for reading-aloud, and the processed page content will be read aloud automatically.

Arranging a “read-aloud” button in a menu of the display interface is an example only. In another example, this button for triggering phonetic reading-aloud may be displayed in vicinity to the content of the second portion which may be read aloud phonetically, other than in the menu.

In step 24, a page content is displayed to the user, after the format of which having been converted into a format that meets the pre-determined requirement, and upon receiving a reading-aloud request from the user, the page content is processed into a form adapted for reading-aloud and the processed page content is read aloud.

In one example where the browser client itself has the page body text content extraction function embedded, the browser client may perform page body text extraction on page content and perform a processing similar to what is described in S23.

In another example, in the case where the browser client itself does not have the page body text content extraction function, the browser client may first send the page content to an application server with this function such as a backend server. The browser client first sends the page content to the backend server, where the backend server performs page body text extraction to the page content. The processed page content is returned from the backend server, and is received and displayed to the user by the browser client. During the display, a “read-aloud” button appears in the menu of the displaying interface. Once it is confirmed that the user has clicked on this button, then the TTS technology may be used to process the page content into a form adapted for reading-aloud, and the processed page content will be read aloud.

In addition, in one example, in order to facilitate the user to locate the current position of reading-aloud, and to smoothly switch between listening and viewing the browser client may mark a word that has been read-aloud with karaoke following mode.

In particular, before a user's reading-aloud request is received, the displayed page content may go through a sentence-separating process by identifying of punctuation marks, so that separate sentences are obtained. Correspondingly, during the time when the displayed page content is being read-aloud, once a sentence has been read-aloud, it will be then marked.

The manner of marking is not limited in the embodiments.

For example, assuming in a normal case, the words of the displayed page content are all in black, then, a sentence may be marked blue once it has been read-aloud. In this way, a user may readily and visually recognize the current reading-aloud position.

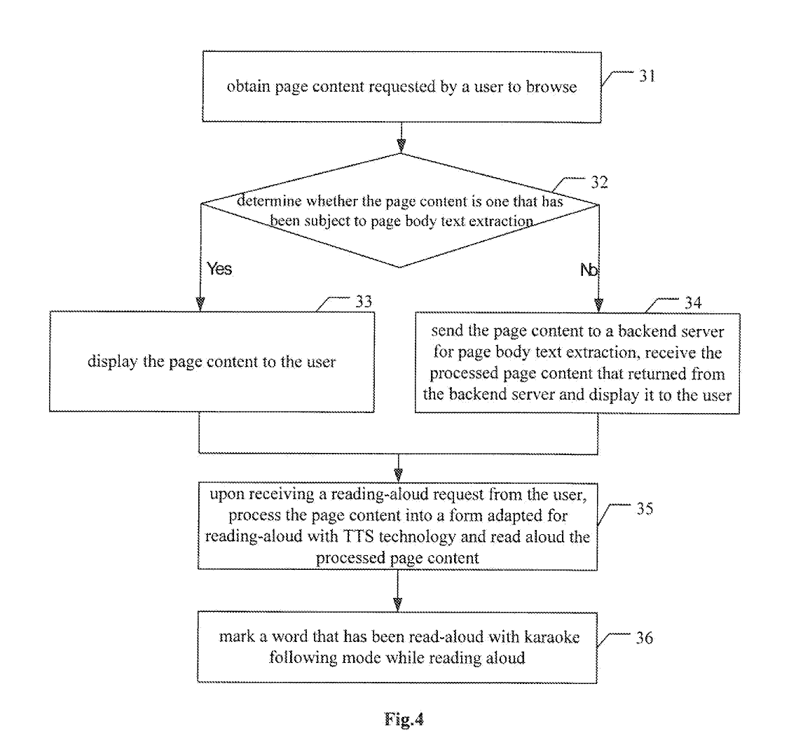

Based on the above illustration, FIG. 4 is a flow chart of a preferred embodiment of an automatic page content reading-aloud method according to an embodiment of the present disclosure. As shown in FIG. 4, the method may comprise the following steps.

In step 31, page content requested by a user to browse is obtained.

In step 32, it is determined whether the page content is one that has been subject to page body text extraction. If yes, then the process proceeds to step 33, otherwise, the process proceeds to step 34.

In step 33, the page content is displayed to the user. Then, the process proceeds to step 35.

In step 34, the page content is sent to such as a backend server for page body text extraction. The processed page content that is returned from the backend server is received and displayed to the user. Then the process proceeds to step 35.

In step 35, upon receiving a reading-aloud request from the user, the page content is processed into a form adapted for reading-aloud with the TTS technology and the processed page content is read aloud automatically.

In step 36, while reading aloud, the word that has been read-aloud is marked with karaoke following mode.

Furthermore, one embodiment of the present invention provides an automatic page content reading-aloud device. FIG. 5 is a schematic diagram of an embodiment of the constituent structure of an automatic page content reading-aloud device according to an embodiment of the present disclosure. As shown in FIG. 5, the automatic page content reading-aloud device may comprise an obtaining module 41 and a reading-aloud module 42.

The obtaining module 41 is configured to obtain page content requested by a user to browse and send the page content to the reading-aloud module.

The reading-aloud module 42 is configured to determine whether a format of the page content meets a pre-determined requirement. If yes, then the page content is displayed to the user, and upon receiving a reading-aloud request from the user, the page content is processed into a form adapted for reading-aloud, and the processed page content is automatically read-aloud. If no, then a page content is displayed to the user, the format of which having been converted into a format that meets the pre-determined requirement prior to the displaying, and upon receiving a reading-aloud request from the user, the page content is processed into a form adapted for reading-aloud and the processed page content is automatically read-aloud.

In one example, the reading-aloud module 42 may particularly comprise a displaying unit 421 and a reading-aloud unit 422.

In one example, the displaying unit 421 may be configured to determine whether the format of the page content meets a pre-determined requirement if yes, then display the page content to the user, and upon receiving a reading-aloud request from the user, inform the reading-aloud unit 422 to perform a reading-aloud function; if no then display the page content to the user, after the format of which has been converted into a format that meets the pre-determined requirement, and upon receiving a reading-aloud request from the user, inform the reading unit 422 to perform a reading-aloud function.

The reading-aloud unit 422 is configured to process the page content into a form adapted for reading-aloud and automatically read-aloud the processed page content.

In one example, the displaying unit 421 may determine whether the page content is one having been subject to a page content extraction, if yes, then it makes a determination that the format of the page content meets the pre-determined requirement, otherwise, then it makes a determination that the format does not meet the pre-determined requirement, sends the page content to a backend server for page body text extraction, and receives the processed page content returned from the backend server.

The reading-aloud unit utilizes a TTS (Text To Speech) technology to process the page content into a form adapted for reading-aloud, and reading-aloud the processed page content.

In addition, the displaying unit 421 may be further configured to, when the reading-aloud unit 422 is reading aloud, mark the word having been read-aloud with karaoke following mode.

The displaying unit 421 may be further configured to after converting the page content into a format that meets the pre-determined requirement and prior to receiving the reading-aloud request from the user, perform a sentence-separating process on the displayed page content.

Correspondingly, once the reading-aloud unit 422 has read-aloud a sentence, the displaying unit 421 marks that sentence.

According to a further embodiment of the present disclosure, there is provided a browser client.

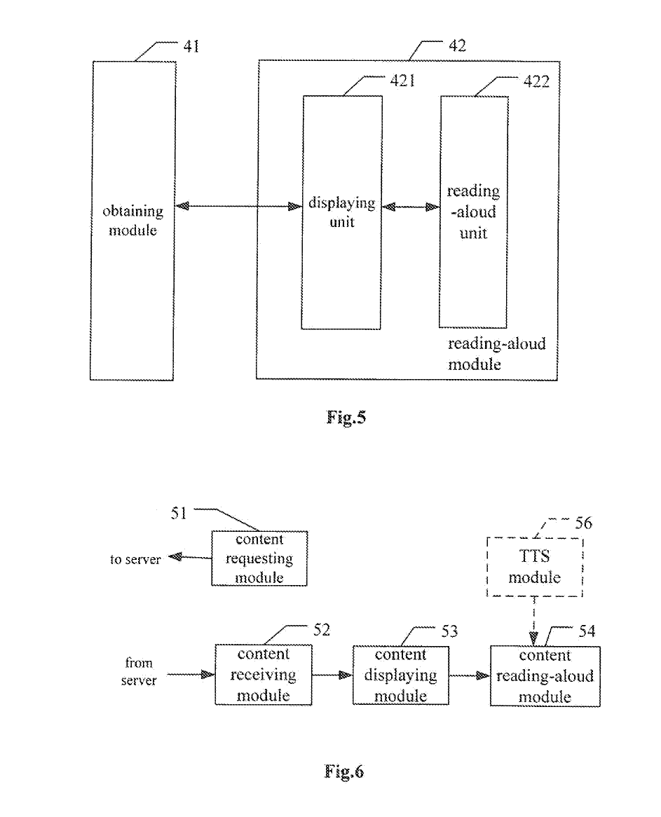

FIG. 6 is a diagram showing a configuration of a browser client according to a further embodiment of the present disclosure.

As shown in FIG. 6, the browser client may comprise: a content requesting module 51, being configured to send a request for page content to a server; a content receiving module 52, being configured to receive page content from the server, wherein the page content having been subject to text content extraction and being divided into a first portion and a second portion, wherein the second portion being a pre-determined portion of content in the form of plain text, derived from the page content having been subject to text content extraction; a content displaying module 53, being configured to display the received page content on a display screen, and display a reading-aloud triggering component for triggering reading-aloud the second portion of the page content; and a content reading-aloud module 54, being configured to output the second portion of the page content in an automatic phonetic form in response to the triggering of the reading-aloud triggering control component.

In one example, the text content extraction that the page content has been subject to can be performed by a second server different from the server.

In one example, the browser client according to claim may further comprise a TTS module, being configured to convert the second portion into data in phonetic form.

In one example, the first portion of the page content may comprise advertisements.

In one example, a head and a tail of the second portion may comprise a pre-determined mark.

In one example, the content reading-aloud module 54 may be configured to locate the second portion of the page content based on the pre-determined mark, so as to output the second portion of the page content in an automatic phonetic form in response to the triggering of the reading-aloud triggering control component.

According to a further embodiment of the present disclosure, there is provided a computer programming product stored on computer readable medium, comprising computer program code, when loaded into a computer system and executed thereon, performs the aforementioned method for automatically reading-aloud page content.

According to a further embodiment of the present disclosure, there is provided a computer readable medium with computer programming product stored thereon, the computer programming product comprising computer program code, when loaded into a computer system and executed thereon, performs the aforementioned method for automatically reading-aloud page content.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What are described above are merely preferred embodiments of the present invention and are therefore not intended to limit the present invention. Any variation, equivalent substitution or modification as falls in the spirit and principle of the present invention are intended to be included within the scope of the following claims.

What is claimed is:

1. A method for automatically reading-aloud page content, comprising:
obtaining page content requested to browse, and determining whether a format of the page content meets a pre-determined requirement;
if it is determined that the format of the page content meets the pre-determined requirement, displaying the page content, and processing the page content into a form adapted for reading-aloud and reading-aloud the processed page content, upon receiving a reading-aloud request;
if it is determined that the format of the page content does not meet the pre-determined requirement, displaying the page content after the format of which having been converted into a format that meets the pre-determined requirement, and processing the page content into a form adapted for reading-aloud and automatically reading-aloud the processed page content, upon receiving a reading-aloud request.

2. The method according to claim 1, wherein,
determining whether a format of the page content meets a pre-determined requirement comprises: determining whether the page content is one having been subject to a page content extraction, if it is, then making a determination that the format of the page content meets the pre-determined requirement, otherwise, then making a determination that the format does not meet the pre-determined requirement.

3. The method according to claim 1, wherein,
converting the page content into the format that meets the pre-determined requirement and displaying it comprises: performing body text extraction on the page content, and displaying the extracted content.

4. The method according to claim 1, wherein, processing the page content into a form adapted for reading-aloud is achieved by a Text To Speech technology.

5. The method according to claim 1, further comprising: marking a word having been read-aloud with a karaoke following mode while reading aloud.

6. The method according to claim 5, wherein,
after converting the page content into a format that meets the pre-determined requirement and prior to receiving the reading-aloud request, the method further comprises: performing a sentence-separating process on the displayed page content;
marking a word having been read-aloud with a karaoke following mode while reading aloud comprises: marking each sentence once it has been read-aloud.

7. An automatic page content reading-aloud device, comprising: an obtaining module and a reading-aloud module;
the obtaining module is configured to obtain page content requested to browse and send the page content to the reading-aloud module;
the reading-aloud module is configured to:
determine whether a format of the page content meets a pre-determined requirement; and
if it is determined that the format of the page content meets the pre-determined requirement, display the page content, and process the page content into a form adapted for reading-aloud and automatically read-aloud the processed page content, upon receiving a reading-aloud request;
if it is determined that the format of the page content does not meet the pre-determined requirement, display a page content after the format of which having been converted into a format that meets the pre-determined requirement, and process the page content into a form adapted for reading-aloud and automatically read-aloud the processed page content, upon receiving a reading-aloud request from the user.

8. The automatic page content reading-aloud device according to claim 7, wherein, the reading-aloud module comprises a displaying unit and a reading-aloud unit;
the displaying unit is configured to:
determine whether the format of the page content meets a pre-determined requirement; if it is determined that the format of the page content meets the pre-determined requirement, display the page content, and inform the reading-aloud unit to perform a reading-aloud function upon receiving a reading-aloud request; if it is determined that the format of the page content does not meet the pre-determined requirement, display the page content after the format of which has been converted into a format that meets the pre-determined requirement, and inform the reading unit to perform a reading-aloud function upon receiving a reading-aloud request;
the reading-aloud unit is configured to process the page content into a form adapted for reading-aloud, and automatically read-aloud the processed page content.

9. The device according to claim 8, wherein,
the displaying unit is configured to determine whether the page content is one having been subject to a page content extraction, and if it is, make a determination that the format of the page content meets the pre-determined requirement, otherwise, make a determination that the format does riot meet the pre-determined requirement, send the page content to a backend server for page body text extraction, and receive the processed page content returned from the backend server.

10. The device according to claim 8, wherein,
the reading-aloud unit is configured to utilize a Text To Speech technology to process the page content into a form adapted for reading-aloud, and automatically read-aloud the processed page content.

11. A browser client, comprising:
a content requesting module, being configured to send a request for page content to a server,
a content receiving module. being configured to receive page content from the server, the page content having been subject to a text content extraction and being divided into a first portion and a second portion, the second portion being a pre-determined portion of content in the form of plain text, derived from the page content having been subject to the text content extraction;
a content displaying module, being configured to display the received page content on a display screen, and display a reading-aloud triggering control component for triggering reading-aloud the second portion of the page content; and
a content reading-aloud module, being configured to output the second portion of the page content in an automatic phonetic form in response to the triggering of the reading-aloud triggering control component.

12. The browser client according to claim 11, wherein the text content extraction that the page content has been subject to is performed by a second server different from the server.

13. The browser client according to claim 11, further comprising:
a TTS module, being configured to convert the second portion into data in a phonetic form.

14. The browser client according to claim 11, wherein the first portion of the page content comprises advertisements.

15. The browser client according to claim 11, wherein a head and a tail of the second portion comprises a pre-determined mark,
wherein the content reading-aloud module is configured to locate the second portion of the page content based on the pre-determined mark, so as to output the second portion of the page content in an automatic phonetic form in response to the triggering of the reading-aloud triggering control component.
